(19) United States
(12) Patent Application Publication
(10) Pub. No.: US 2016/0183543 A1
(43) Pub. Date: Jun. 30, 2016

(54) METHOD AND DEVICE FOR TREATING FOOD BY MEANS OF A HEATING PROCESS

(71) Applicants: TRITON GMBH, Berlin (DE); DEUTSCHES INSTITUT FÜR LEBENSMITTELTECHNIK E.V., Quakenbrück (DE)

(72) Inventors: Fritz Kortschack, Berlin (DE); Werner Gr. Kohorst, Dinklage (DE)

(21) Appl. No.: 14/911,374

(22) PCT Filed: Jul. 30, 2014
(86) PCT No.: PCT/EP2014/066370

§ 371 Date: Feb. 10, 2016

(30) Foreign Application Priority Data
Aug. 16, 2013 (DE) 10 2013 013 668.7
Dec. 6, 2013 (DE) 10 2013 020 411.9
Mar. 13, 2014 (DE) 10 2014 003 649.9
Apr. 14, 2014 (DE) 10 2014 005 493.4
Jul. 9, 2014 (DE) 10 2014 010 166.5

(51) Int. Cl. A23B 4/015; A23L 3/01

(52) U.S. Cl. CPC A23B 4/015; A23L 3/01; A23V 2002/00

(57) ABSTRACT

The invention relates to a method for treating food, in particular meat or sausage products, by means of a nonconventional heating process, in particular an ohmic heating process, having the following steps:—filling a dimensionally stable shell or a shell which is made dimensionally stable by additional means, said shell being made of a nonconductive material, with a filling material, in particular with sausage or a similar raw food product,—closing openings of the shell with conductive surfaces, in particular panels, plungers, or stoppers, and—conducting an electric AC voltage via the conductive surfaces and conducting the current through the filling material while the filling material moves relative to the conductive surfaces for a uniform ohmic heating process.

The invention relates to a method for treating food, in particular a sausage product, by means of a nonconventional heating process, in particular an ohmic heating process.

Conductive heating, which is also known as ohmic heating, represents an alternative that can be used in industry for the classic heating of food. The functional principle of this electrothermal method is based on the direct conduction of current through the product. The food product itself assumes the function of a heating resistor. Ohmic heating offers the advantage over classic heating that the electrical current heats the product virtually without any time delay once the voltage is applied. In particular, heating in the interior of the product can principally also occur immediately.

It is problematic however that in the case of liquid food products with partly solid pieces only the liquid is heated at first because pieces of fruit, vegetable or meat have a substantially higher electrical resistance than the liquid. That is why the current predominantly only flows through the liquid components of the product according to the law of the least resistance, which will then only gradually heat the pieces according to thermal conductivity.

It is known from the prior art with classic heating that sausage meat is filled into artificial sausage skin and is heated in an apparatus, e.g. a boiling cabinet, a water bath or the like, depending on the calibre for such a time until the desired core temperature has been reached. This tempering can take several hours.

The heating in the sausage skin leads to the consequence that during suspended heating a stronger expansion occurs in the bottom region of the sausage skin as a result of the weight of the content of the sausage skin. In addition to the uneven expansion it can be observed that the ends of the sausage skin taper in a round or peaked manner, thus producing uneven slices when the sausage is cut later on. The long production processes require respectively large production areas, which are actually needed by the long process times since a careful heating process is necessary.

It is the object of the invention over this prior art to provide a method and a device for producing food in which one or several of the aforementioned problems do not occur.

In particular, the production of shaped food products shall be enabled, which maintain their dimensional stability by heating and subsequent cooling. Such dimensional stability is required for example in order to cut a sausage into even slices for a package of cold cuts. Furthermore, the product yield shall be increased due to reduced losses of liquid and meat protein.

This object is achieved in accordance with the invention by a method according to claim 1, wherein the dependent claims at least represent appropriate further developments.

It is thus provided that the treatment method comprises the following steps:
filling of a dimensionally stable shell or a shell which is made dimensionally stable by additional means, said shell being made of a non-conductive material with a filling material, in particular sausage meat or a similar raw food product;
closure of openings of the shell with conductive surfaces, in particular plates or plugs, and
supplying an electric current via the conductive surfaces and conducting the current through the filling material.

It is further provided in accordance with the invention that a device is formed, comprising
a dimensionally stable shell made of non-conductive material, wherein the shell comprises at least two opposite openings;
conductive surfaces which seal the openings, especially plates and/or plugs, and
a current source for generating a current which flows via the conductive surfaces through a filling material stored in the shell.

The method provides in an embodiment in accordance with the invention to carry out the known ohmic heating process for sausage meat or similar raw materials in an enclosed random form whose surfaces consist of non-conductive materials and which can be sealed on opposite openings by conductive surfaces, plates, plungers or plugs.

Current can be injected into the conductive closures, which are formed in the manner of flat electrodes. The functional principle of this electrothermal method is based on the direct conduction of current through the filling material. The food product itself assumes the function of a heating resistor.

Ohmic heating offers the advantage in comparison with classic heating that the electrical current heats the products virtually without any time delay once the voltage is applied. Notice must further be taken that a product carefully treated by ohmic heating shows distinctly lower cooking (juice) losses than conventionally heated products. Ohmic heating represents a simultaneous heating of the entire raw material without outer product layers being subjected to stronger drying as is the case in conventional thermal heating, caused by an action of heat from the outside to the inside. In addition to a lower loss in raw products pretreated by ohmic heating, a greater volume of inserted material pretreated in this manner is achieved, which occurs in aspic products for example by a visually improved slice image as a result of the ratio between the added meat and gelatine. It was surprisingly noticed that fresh meat pretreated by means of ohmic heating will dry out to a considerably lower extent in a subsequent roasting or also cooking process, and therefore shows a higher degree of tenderness due to the high volume, among other things. The temperature of the preheating of the fresh meat should lie above 42° C., the start of denaturation of meat protein.

In the case of a pretreatment of raw material for the production of liver sausage for example by means of ohmic heating, it was recognised that respectively produced products, in addition to a higher yield, show no negative deviations from conventionally produced cooked sausages. No deposits of grease or jelly can be recognised. This allows drawing conclusions that the meat protein present in the raw material is utilised completely. In the case of conventional heating on the other hand, protein is lost with the boiling vessel water, or drying occurs in such a way that the protein is no longer available for the formation of a protein net. The ohmic heating can therefore replace pre-treatment in the cooking bowl cutter, cooking mincer or boiling vessel. It is further possible to avoid the use of emulsifying agents or other auxililary agents or additives, which are required otherwise.

The already precooked material is mixed and chopped in the production of the aforementioned cooked sausage products. It is also possible to mix and chop non-precooked raw material (raw) according to the recipe. The completed mixture can then be brought to the desired temperature by means of ohmic heating. Such a treatment method guarantees finished products which are free from grease and jelly deposits and which have the desired consistency in combination with high yield at the same time.

Means can also be regarded as “dimensionally stable shells” for heating unpacked raw materials which are shaped like a cooking vessel for example. Such means also consist of non-conductive materials or conductive materials, but comprise one or several triggerable contact surfaces via which the supply of current can occur, which contact surfaces are provided as bottom or lateral boundaries or covers opposite each other. In contrast to a cooking vessel, notice must be taken that the entire accommodating space must be filled with as few air pockets as possible and is additionally secured, so that the treatment material is provided with close contact (optionally by pressure) with the current-conducting surfaces.

It is further possible in a further development that an electrode is inserted centrally in the vessel mould and the entire outer shell acts as a counter-contact.

It can be derived from the above that the contacts or contact surfaces can be provided with a large variety of geometries, e.g. straight surfaces, curved surfaces, round bars, balls etc.

It is necessary for the constant heating of the treatment material that the treatment current is forced to flow as evenly as possible through all components of the treatment material, which represents itself as an electrical resistor.

If for example a contact which is positioned centrally in a treatment container and has the shape of a ball represents a first contact surface, it is advantageous to use a shell made of a conductive material as the second contact or contact surface, wherein the shell also has the shape of a sphere or spherical segment and the sphere encloses the first contact surface.

It is clearly understood by the person skilled in the art that a respective decoupling between the contact surfaces is provided by sufficient insulation.

The aforementioned central contact can produce mixing of the treatment material by its own movement, but can also reach regions of the treatment material by changing its own position which otherwise would not be positioned optimally with respect to the contact, e.g. in an angular metal container as a large-area contact and counter-contact in form of a sphere. This treatment method for raw materials which are usually further processed can occur in an open container because the treatment material is moved continuously and potential air pockets will obstruct the electrical current flow only briefly.

It applies from the above that depending on the shape of the treatment container and/or the positioning of the contact surfaces therein, a respectively optimal shape and positioning of the counter-contacts must be chosen.

If a container with a metal outer shell for accommodating the treatment material is used, the metal outer shell can simultaneously act as a contact surface. A central rod is positioned in the container in a bottom which is not conductive in this respect, which rod forms the counter-contact surface. Such a container can be formed and used not only in a stationary manner, but also as a mobile transport, feed, storage or similar unit.

The contact surfaces can additionally carry out chopping and/or mixing functions, e.g. they can have the shape of blades for example. The respective functions such as application of current, mixing and/or chopping can be made in a respective time sequence or also simultaneously.

After the ohmic heating of the filling material, the conductive surfaces (plates and/or plugs or plungers) can remain as a closure in the shells, but can also be removed and caps can be applied which seal the shells.

It is provided in an embodiment of the invention that the dimensionally stable shell simultaneously represents a contamination-free transport package for the finished product, wherein the shell is preferably formed in a tube-shaped manner in such a way that the shell cross-section defines the shape of the product. For improving the sliding capability of the treatment material, it can be surrounded by a film and introduced into the dimensionally stable shell. It is ensured by a respective configuration of the shell (open ends or provided with contacts) that the application of current can occur.

The shell per se can also be formed in an embodiment of the invention as a dimensionally stable box which accommodates the treatment material.

As a result, it is no longer necessary to separately repack the food product within the production plant or prior to the delivery to the sales locations, and the likelihood of contamination is reduced considerably. It can especially be provided that the semi-finished goods, after the heating process, are directly supplied to the cutting process still in the dimensionally stable shell or are cooled beforehand. A re-contamination is excluded by such procedure until the removal for the cutting process.

If for example cured pork with bone is subjected to ohmic heating, the use of the aforementioned dimensionally stable shell can prove to be problematic. Alternatively or in addition, the application of flexible shells can occur in the case of a treatment material with bone, or a combination of a flexible/dimensionally stable shell can be used. It is relevant that the material is surrounded completely and the current flow occurs through the entire material. It is understood that the combined flexible/dimensionally stable shell can also be used in treatment material without bones.

It is provided in a further embodiment of the invention that the shell is formed in a tubular manner and the conductive surfaces are flat surfaces which form the base and/or cover surface of the tube.

In the case of a tubular, i.e. cylindrical, configuration, the cross-section can be circular, oval, angular, especially quadrangular, or heart-shaped. A large variety of configurations of the cross-section can be provided by the dimensional stability of the shell. Slices from sliced products formed from the filling material are always constant in this embodiment, up to the surfaces formed as end pieces.

A tubular or comparatively elongated configuration of the shell allows an especially simple production of the food product. As a result, the conductive surfaces can be placed on the openings of the shell for heating the conductive surfaces and an electric contact can thus be produced with the filling material. After the ohmic heating, the conductive surfaces can then remain as a closure in the shells or can also be removed, and the openings of the shell can be sealed by caps. After the delivery of the product to the customer (e.g. consumer markets), one or both openings can be reopened by removing the plugs or caps for example, and the finished product can be pressed out and sliced. An especially efficient and hygienic production is thus possible.

The caps applied after the removal of the conductive surfaces can be connected to the shell via a sealed seam. The customer can thus recognise that the food product has not yet been opened.

The caps can also be curved inwardly and can be fixed to the shell from the inside.

The removal of the conductive surfaces and the attachment of the caps can occur under vacuum atmosphere. A contamination of the product can thus be prevented.

If narrow-calibre products such as small sausages are provided with rounded portions similar to a sausage skin, then this is also possible, up to the usual additional longitudinal grooves in the end rounded portions which are produced when filling a sausage skin.

Small sausages or sausages (meat sausages or the like) can be taken in the still heated state from the rigid shells, be repacked into end consumer packages and subsequently only require very short surface heating in the final packaging so that potential re-contaminations are made harmless during the removal from the rigid shell and the packing in vacuum packaging, brine bags or cans with possibly preheated brine.

It is provided in a further embodiment of the invention that the filling of the dimensionally stable shell occurs by a plug to be displaced.

The filling of the moulds should occur against a plug to be displaced in order to avoid air pockets.

It is provided in a further embodiment of the invention that after the filling the used plug remains in the mould or a sealing cap is applied and fixed in a pressure-proof manner.

As already mentioned above, the sealing cap can be applied under vacuum atmosphere and/or can be sealed by a sealing seam with the dimensionally stable shell.

It is provided in an embodiment of the invention that the ohmic heating can occur continuously but also in intervals so that a temperature adjustment, i.e. a temperature compensation process, in the treatment material can already occur during the heating process. In addition, the heated filling material can be stored within or outside of the stable form for harmonizing the temperature for a specific period of time, especially at least 2 minutes, preferably at least 10 minutes, at a predefined temperature, especially the desired core temperature of the finished product.

Only the liquid is heated at first in liquid food products with pieces, because fruit, vegetable or meat pieces have a substantially higher electrical resistance than the liquid. That is why the current flows according to the law of the least resistance mainly through the liquid components of the product, which then heat the pieces according to thermal conductivity. It is necessary as a result of this phenomenon to store the heated products for harmonizing the temperature for a specific period of time in an environment which ideally corresponds to the desired core temperature of the semi-finished product.

It is provided in a further embodiment of the invention that the filling material is compacted before, during and/or after the ohmic heating by pressure, especially by pressure applied from the outside.

The sealing plunger can thus be introduced after the filling process and the filling material can be compacted before and during the heating by means of ohmic heating for securing a solid consistency. An especially high dimensional stability and uniform consistency of the finished product can thus be achieved. It is a further possibility that the filling process occurs through a sealing plug which has an opening.

It is provided in a further embodiment of the invention that the shell is rotated before, during and/or after the ohmic heating.

The liquid can be distributed more evenly within the filling material as a result of the rotation, which is preferably carried out at a low rotational frequency of less than five rotations per minute for example. In particular, deposits of liquid on the bottom side are avoided, which would then also lead to unilateral heating on the bottom side.

It is provided in a further embodiment of the invention that the shell comprises or consists of a plastic block provided with several boreholes.

Such a shell can be produced especially easily and allows an especially stable storage of the filling material. The plastic block can represent the packaging of the finished product. Several food products, e.g. several sausages, can thus be housed in a package. Sausages of different flavours can be housed in a package for example. They can be pressed out individually through the tubular boreholes. Simple and hygienic storage of different food products is thus enabled.

The shell can be formed as a reusable packaging in an embodiment of the invention. After the consumption of the food product, the packaging can be filled with filling material again and can be heated in accordance with the invention.

It is provided in a further embodiment of the invention that several shells are filled jointly and they are separated later on, especially after ohmic heating.

For example, two shelves can be connected to each other in form of an “8”, filled and heated jointly, and then separated.

For example, predetermined separating points can be provided on the plastic block, and the plastic block can be dismantled into a plurality of dimensionally stable shells.

An especially efficient mass production of the food product can thus be realised.

There is a possibility in one embodiment of the invention that the application of current to the treatment material is carried out in intervals. Accordingly, a silent interval follows a current-application interval for harmonizing the temperature in the product. The respective period of time of the interval can be selected on the basis of the product properties, e.g. the thermal conductivity.

After the filling and the ohmic treatment of the product situated in the shell or cartridge, the dimensionally stable shell can be supplied to a slicing machine directly after the treatment or also with a time delay. After the removal of the provided plug, the filling material can be pressed out of the cartridges and can be cut into slices either in the hot or cold state. The stabilising shell ensures that despite a consistency of the product that may not yet be ready for slicing a constant shape of the slice is still achieved, because only a small portion of the product is pressed out for guiding the cutting. The obtained slices can be packaged in the hot state and are therefore insensitive to contamination. A movement of water vapour occurs here from the hot slice to the colder ambient environment.

The aforementioned method allows a virtually fully automatic production of sliced products in addition to the packaging, ranging from the filling process of the cartridges up to the sorting of the merchandise. Required intermediate steps such as the cooling of the packaging and price labelling can easily be integrated in the process.

A relative movement between the filling material and the conductive surfaces used as current-application electrodes is produced in a preferred further development of the method of the non-conventional heating of raw materials for food products in accordance with the invention, especially meat or sausage products, so that the ohmic heating occurs independently of the consistency of the filling material in an even manner without local overheating or insufficiently heated regions.

In addition to the aforementioned type of current application, the structure of coarse pieces such as pieces of ham can be loosened prior to treatment by a plurality of small knives (tenderisers), so that layers of collagen or fat only produce a very low discharge of the current flow.

For the further improvement of the approach made to solve the problem in accordance with the invention, the filling material can be subjected to high-frequency heating after, during and also before ohmic heating, so that a more rapid achievement and maintenance of the respective core temperature is ensured in the filling material.

In the case of products with large veins of fat, e.g. belly, the lean meat content is heated in the desired manner by ohmic heating with the thus resulting advantages such as improved binding of water and yield. If in this case a high-frequency treatment is additionally carried out, the fat layers, which otherwise may not be sufficiently heated, can be brought to the desired temperature, which will usually be kept at a lower level in order to prevent bursting with the consequence of greasiness of the fat cells.

It has been recognised that pure high-frequency heating meets its limits at diameters of the filling material in the range of 10 cm. If the high-frequency heating is combined in this respect with ohmic heating, heating can be achieved more rapidly by forming purposeful current paths, e.g. especially within a longitudinal core axis in the filling material, and the desired core temperature can be maintained, so that the treatment time is reduced in general and the energy input is provided more efficiently. The high-frequency energy is provided by a generator which provides high-frequency oscillations in the range of substantially 5 to 50 MHz. This high-frequency energy is injected into the filling material, which is preferably situated within a Faraday cage. In this case, both a discontinuous and also a continuous (pass-through) treatment can be considered.

Different components in the filling material, e.g. lean meat, fat, muscle fibres and the like, can be heated in a defined manner by an additional amplitude or frequency modulation, or also by superimposing higher-frequency oscillations relating to the initial range of 5 to 50 MHz. This provides the possibility of compensating disadvantages of the heating process due to different conductivity properties of the respective components.

In the case of the additional or supplementary heating on the basis of the action of high-frequency energy, the filling material is used as a dielectric within an oscillating circuit capacitor. The adjustment of the oscillating circuit can be used to respond to different properties of the filling material that may optionally change, so that the desired process reliability is ensured.

There is the possibility of continuous treatment by ohmic heating according to the invention in a further development of the invention, especially in the production of sausage products. Continuous production can thus be ensured in that an electrode element follows the filling material situated in the dimensionally stable shell according to the pig principle and a predetermined quantity of filling material follows etc. The application of current is then possible concerning the resulting segments via the electrodes which embedded in a pig-like manner, which come into electrical contact during continuous movement through the dimensionally stable shell with the respective contacts, which are provided in different distances and lengths (elements to be screwed in) according to the required treatment time, in order to conduct a current over a period of time defined in this manner depending on the filling speed during the movement of the filling materials in addition to the pig electrode in the shell.

The movement through the quasi-continuous chain of filling material, pig etc can be realised by means of pressurisation or a conventional vacuum filler or the like. It is possible to form the contour of the “pig” in such a way that the image of a round sausage skin end is achieved in order to obtain the typical ends of a sausage in the production of small sausages for example.

In an embodiment of the invention, which forms a further development thereof, the treatment material can be subdivided into sections within the shell by conductive boundaries, e.g. discs made of conductive material. These conductive boundaries lead to a homogenising of the current flow on the one hand and thus to an evening of the ohmic heating. On the other hand, individual pieces of the treatment material with a straight cut are achieved, which increases the yield. Finally, a subdivision within the terms of portioning can be carried out by the conductive boundaries.

Experiments have shown that the material taken from the dimensionally stable shell can be cut into slices. There is a likelihood however depending on the consistency of the treatment material that the cut slices will warp. In accordance with the invention, the treatment material can be moved out of the shell or the moulding box to such an extent that the treatment material will strike a stop, which is usually represented as a flat surface of a retaining apparatus. The material is stabilised in this manner by the surface of the retaining apparatus and can be cut without any deformation. A further respective dimensional stabilisation is provided in such a way that the surface of the retaining apparatus comprises boreholes of a small diameter or it consists of a finely-woven net. The cut slice can be fixed to the surface by means of vacuum, so that even an unstable product can be stabilised. In the case of a desirable automation process, the retaining apparatus can simultaneously be used as a means for transferring the slice-shaped product which is retained on its surface, e.g. to a packaging for a final product. Manual contact of the product, and the respective sliced products in particular, can thus be avoided.

The cutting of the treatment material into slices or respectively flat pieces can occur in such a way that a rotational movement of the material is initiated once it has been moved out of the dimensionally stabilising shell. A cutting movement is performed by the rotational movement in conjunction with an applied blade, which occurs by avoiding abrasion which occurs otherwise and which is represented as product flags. The employed blade can concern a blade supported by ultrasonic sound. The aforementioned, briefly explained technology of cutting into slices or pieces can be realised in a preferably contamination-free manner, because the product is subjected to the desired cut directly after being moved out of the shell. Contamination of the product is excluded by avoiding manual contact.

If fresh meat is treated by means of non-conventional heating, and ohmic heating in particular, the effect occurs that during a subsequent roasting or cooking process the fresh meat treated in this manner will dry out to a lower extent and show a higher degree of tenderness. The temperature of the pretreatment of the fresh meat by the preferred ohmic heating shall lie in this case above 42° C., which is the start of the denaturation of meat protein. The fresh meat that is treated with ohmic heating in one piece can reach the end consumer in a respectively packaged manner and is subjected there to a final preparations step, especially a roasting step for forming a crust. The desired tenderness of the product is thus produced in a reproducible manner and does not depend on the skill or the equipment concerning the final preparation of the meat.

In addition to the aforementioned positive effect of ohmic heating on fresh meat, which was gained within the scope of a conventional slaughtering and meat-cutting process, a termination of undesirable biochemical processes occurs as a further positive effect as a result of ohmic heating before the commencement of rigor mortis. This is caused by the occurring protein denaturation at the aforementioned treatment temperature of more than 2° C. and a prevention or exclusion of undesirable cold- or hot-shortening.

Although the treatment of meat and sausage products is principally discussed in the explanations above, the treatment of other food products such as cheese, tofu or the like is obviously also possible by means of ohmic heating. On the one hand, ohmic heating can be realised in containers which are marketed at a later time as a fully preserved canned product. The product which is situated in the container and fills the same is then heated via the conductive lid in a can made of a non-conductive material and is finally packaged in a contamination-free manner. Ohmic heating is also principally used for the treatment of such raw materials for food products which are supplied to further processing such as the heating of meat for the production of liver sausage, corned beef or the like. As a result of a purposeful selection of temperature, the treated raw material, for the production of meat balls for example, can be preset in such a way that the achievement of a specific target property such as good juiciness in combination with loose consistency is ensured.

The following procedure is carried out in one embodiment of the invention, namely the treatment of raw sausage stuffing. Raw sausage meat is usually filled in the cold state into a sausage skin in order to obtain a clear image and to prevent a lubricant film. The raw sausages are then brought to a climatic chamber in which the raw sausage stuffing is tempered. The temperature allows that microorganisms become active and the raw sausage meat acidifies. The temperature during this treatment phase in the climatic chamber usually lies in the range of between 22° C. and 28° C. Once the pH value of the raw sausage material has reached the isoelectric point with high water release property of approximately pH 5.3, drying of the raw sausages commences. The surface of the sausage shall not be dried until reaching the isoelectric point because otherwise a so-called dry edge is produced, which in the end impairs or prevents the water release.

The high air humidity that usually prevails during this period in the usually employed climatic chamber, in combination with the relatively high temperatures, supports the increase and contamination by undesirable microorganisms or mould and yeast fungus on the sausage surface. Errors that are made in this temperature adjustment or acidifying phase of approximately 1 to 3 days can decide in general on the success of production batch.

Raw sausage stuffing, which is filled into cartridges even in the very cold state, can be permanently further compacted by closures and pressure. The closer the individual particles are situated adjacent to each other in the finished product, the more colourful the product appears. According to the embodiment, ohmic heating is then carried out at the aforementioned temperatures in the range of 22° C. to 28° C. Since the sausage meat merely needs to be acidified for gel formation during the first one to three days of production, the sausage meat can remain in the cartridges, optionally also under pressure, so that no influence can be made from the outside on the semi-finished goods by microorganisms for example. For the purpose of maintaining the temperature, the tightly sealed cartridges can be intermediately stored in a tempered room, but also in a water bath. Once the desired isoelectric point has been reached, the already solidified raw sausages can be taken from the cartridges and can be dried, smoked or matured in the known climatic chambers until they are finished.

As a result of this production sequence according to the embodiment, the occupancy of the climatic chambers in the first production phase can be avoided. The required energy input for conditioning the chambers can be avoided. There is positive support in the consistency formation of the raw sausage material by the optional additional and high-pressure application on the raw sausage material during the first phase. During the filling process of cold raw sausage stuffing, narrow filling passages (e.g. for filling a flexible sausage skin) can be avoided, thus supporting a very clear raw sausage image and optimal water release property. Furthermore, the formation of a grease film caused by soft fat is also counteracted.

According to a further embodiment, the treatment of sausage skin products can also be optimised by ohmic heating. As a result, a strand of sausage meat can be filled into a shell shape, especially a half-shell. A distribution of the sausage meat occurs by the application of a custom-fit upper shell in such a way that it is subjected to even distribution between conductive sections incorporated in the shells. The desired even distribution and displacement of the sausage meat is achieved by an approach to the conductive boundaries during the application of placement of the upper shell. A current flow commences after the contact halves come into contact or when they come into contact. After a very short treatment period, the thus solidified raw sausages can be removed. It is understood that a material for surface treatment can be applied to the inside of the shells prior to the introduction of the sausage meat into the shells, e.g. a so-called smoke powder or a flavour.

The shell arrangement can consist not only of several strips situated adjacent to each other, but can also consist of several members which are continuously circulated via a wheel. The slicing of the heated raw sausages can occur during the contact with the shells or plates. This simultaneous treatment ensures that the raw sausages, after the removal from the shelves/plates, are present in a sorted manner and can be introduced directly by suitable grippers into the respective packaging.

A device formed in this manner can also be used for the solidification of products which are filled into a conductive (natural) sausage skin. A separation between the sections of the semi-finished goods occurs by the compression of the contact elements, so that the solidified raw sausages can be removed after the treatment by means of current. The raw sausages are subjected to pressure during the actual current treatment, so that it is ensured that the finished products have the desired solid consistency. The respective shape or diameter of the finished products can be realised via the shaping of the aforementioned shells or half-shells. The introduction of the current or the contacts can occur at will. The shells or half-shells accommodating the sausage meat strand can consist of a non-conductive material or can be provided with an insulating layer. It is thus possible to separate the shaping components from the contact components and to respectively optimise them separately.

Notice must be taken as a result of examinations made up to this point that the ohmic heating ensures through the simultaneous and very rapid heating of the respective products at virtually any position of the product that microorganisms are unable to adjust to a changed temperature environment, which inevitably occurs during slow treatment. The contamination by microorganisms is thus lower in comparison with conventional pasteurisation or preservation. Furthermore, the damage to the product is lower by ohmic heating than in conventional heat treatments, which is caused by the better protein net formation and lower drying rate of the products to be treated. The heated and rapidly packed products can become so secure by a subsequent, generally known high-pressure treatment in an insulating feed container by the renewed heating and high-pressure effect that preservation is quasi consequently provided without encountering the negative changes in taste that occur otherwise during the action of high temperatures. Selected products can thus be marketed without cooling, which products are comparable with respect to quality and taste with conventionally produced qualities that need to be cooled however.

It is also possible by means of ohmic heating to simultaneously heat food products, especially meat and meat products, at any point in such a way that the proteins present are subjected irreversibly to denaturation by the heating. Products, which are subjected in advance to only low ohmic heating by approximately 55° C. such as bratwurst, cured pork, roast or the like, can be reheated to the desired eating temperature prior to later consumption and have properties with respect to consumption, enjoyment and taste which are at least comparable to products of the prior art. The products that are mildly heated in this manner in advance offer the advantage that the degree of tenderness, the desired juiciness (i.e. water binding) is higher by the preceding even heating than in such products which consist of untreated preparations.

It has been recognised in the practical application of the method in accordance with the invention that an increase in the surface of the treatment material is advantageous for constant supply of current. Tendon plates or tendon strands, layers of fat or the like, components that reduce the current flow, are opened in advance, e.g. slit open by a knife. A structure which is optimised for the penetration of liquid at the cutting points is thus produced. Products are preferred which are treated by means of ohmic treatment, are salted and/or sprayed with brine in advance. Respective salt and/or liquid can penetrate through openings created by the blades and thus produce a current-optimising change, so that constant heating also occurs in layers enclosed by collagen or fat. The created interfaces are not visible and not disadvantageous after the treatment by means of ohmic heating. Products treated by means of ohmic heating are assigned to the product group of produce. As a result, the product range to be treated in accordance with the invention thus comprises treated (marinated, salted etc) or untreated meat for roasting or cooking and generally known sausage or meat products, as already explained above.

1. A method for treating a food product, in particular meat or sausage products, by means of a nonconventional heating process, comprising the following steps:
filling of a dimensionally stable shell or a shell which is made dimensionally stable by additional means, said shell being made of a non-conductive material, with a filling material, in particular sausage meat or a similar raw food product;
closure of openings of the shell with conductive surfaces, in particular plates, plugs or plungers, and
supplying an electric current via the conductive surfaces and conducting the current through the filling material under relative movement between the filling material and the conductive surfaces for constant ohmic heating.

2. A method according to claim 1, characterized in that the dimensionally stable shell simultaneously represents a contamination-free packaging, especially a transport packaging, for the finished product, wherein the shell is preferably formed in such a way that the shell cross-section defines the shape of the product.

3. A method according to claim 1, characterized in that the shell is formed in a tubular manner, and the conductive surfaces are flat surfaces which form the base and/or cover surface of the tube.

4. A method according to claim 1, characterized in that the filling of the shell occurs against a plug to be displaced, and/or an end cap is applied and fixed in a pressure-proof manner after the filling.

5. A method according to claim 1, characterized in that after the ohmic heating the heated filling material is stored for harmonisation of the temperature for a specific period of time, especially approximately 2 minutes, preferably at least 10 minutes, at a predefined temperature, especially the desired core temperature of the finished product.

6. A method according to claim 1, characterized in that the filling material is compressed before, during and/or after the ohmic heating by pressure, especially by pressure applied from the outside.

7. A method according to claim 1, characterized in that the shell rotates during the ohmic heating.

8. A method according to claim 1, characterized in that raw materials heated by means of ohmic heating are subsequently chopped, mixed or filled in the hot or re-cooled state, and the deposit of jelly or fat in the finished product is prevented by the pretreatment.

9. A method according to claim 1, characterized in that several shells are filled jointly, and they are separated later, especially after ohmic heating.

10. A method according to claim 1, characterized in that the filling material is subjected to high-frequency heating after, during or before ohmic heating, so that a more rapid achievement and maintenance of the respective core temperature in the filling material is ensured.

11. A method according to claim 10, characterized in that the high-frequency energy is provided by oscillations in the range of substantially 5 to 50 MHz and is injected into the filling material, wherein different components in the filling material can be heated in a defined and purposeful manner by a additional amplitude or frequency modulation.

12. A method according to claim 10, characterized in that the filling material is used and heated as a dielectric within an oscillating circuit capacitor.

13. A method according to claim 1, characterized in that the dimensionally stable shell comprises a coating, especially an inner coating.

14. A method according to claim 4, characterized in that the filling of the shell occurs against a current-conducting plug to be displaced, or after the filling a current-conducting plug or a current-conducting separating plate is introduced according to the pig principle, which is supplemented by a further filling section with further current-conducting plugs or a current-conducting separating plate.

15. A method according to claim 1, characterized in that the filling material is moved out of the shell and is pressed against a stabilising stop and is cut into slices.

16. A method according to claim 1, characterized in that the treatment material of a meat product is subjected to constant ohmic heating in such a way that temperatures above 42° C. are maintained in the fresh meat over a predetermined period of time in order to prevent reductions in the quality as a result of biochemical processes and to maintain the degree of tenderness of the treatment material even during subsequent roasting or cooking processes.
